(19) United States
(12) Patent Application Publication
(10) Pub. No.: US 2014/0071317 A1
(43) Pub. Date: Mar. 13, 2014

(54) IMAGE PICKUP APPARATUS

(71) Applicant: PANASONIC CORPROATION, Osaka (JP)

(72) Inventors: Michihiro Yamagata, Osaka (JP); Norihiro Imamura, Osaka (JP); Tsuguhiro Korenaga, Osaka (JP)

(21) Appl. No.: 14/009,184

(22) PCT Filed: Feb. 1, 2013
(86) PCT No.: PCT/JP2013/000564

§ 371 Date: Oct. 1, 2013

(30) Foreign Application Priority Data
Feb. 2, 2012 (JP) 20121-021192

(51) Int. Cl. H04N 5/355; H04N 5/235; H04N 5/225

(52) U.S. Cl. CPC H04N 5/355; H04N 5/2254; H04N 5/2355
USPC 348/279; 348/340

(57) ABSTRACT

An image pickup apparatus disclosed in this application includes: a lens optical system (L) including a first optical region and a second optical region; an image pickup device (N) including at least a plurality of first pixels and a plurality of second pixels where light transmitted through the lens optical system (L) enters; an area segmented optical attenuator device (W) including a first light control part and a second light control part, which are located in the first optical region and the second optical region, respectively; a control section (V) for changing at least one of a transmittance of the first light control part of the area segmented optical attenuator device and a transmittance of the second light control part of the area segmented optical attenuator device; and an array-patterned optical device (K), which is placed between the lens optical system and the image pickup device, for causing light transmitted through the first optical region to enter the plurality of first pixels and causing light transmitted through the second optical region to enter the plurality of second pixels.

### TECHNICAL FIELD

This application relates to an image pickup apparatus, and more particularly, to an image pickup apparatus capable of obtaining an image that has a wide dynamic range.

### BACKGROUND ART

In recent years, digital still cameras that use a solid-state image pickup device have become popular and are widely used. These digital still cameras take pictures generally by adjusting exposure conditions for the main subject. In the case where the contrast between light and dark is great in a shot scene, the obtained image may have a blackout area in the dark portion or a whiteout area in the light portion.

Digital cameras, however, allow performing image processing on an obtained image. For instance, a wide dynamic range image that is less afflicted by the blackout/whiteout phenomenon can be generated by taking a plurality of images at varying exposure conditions, performing image processing within the camera body, and compositing the plurality of images. This function is called high dynamic range (HDR) imaging, and cameras equipped with the function are commercially available.

As a method of expanding the dynamic range in a solid-state image pickup device, in Patent Document No. 1, there is disclosed a technology with which a pair of photodiodes having different sensitivities are arranged as one pixel and processing of synthesizing outputs of the pair of photodiodes is executed. In Patent Document No. 2, there is disclosed a technology with which a plurality of photoelectric conversion parts whose light-receiving surfaces have different planar dimensions are used as one pixel unit.

In Patent Document No. 3, there is disclosed a technology with which a compound-eye optical system made up of a plurality of lens optical systems is used to photograph under a different exposure condition with each different lens optical system and the photographs are composited by HDR composition.

### CITATION LIST

### Patent Literature

Patent Document No. 1: Japanese Patent No. 4018820
Patent Document No. 2: Japanese Patent Application Laid-Open Publication No. 2011-114680
Patent Document No. 3: Japanese Patent Application Laid-Open Publication No. 2002-171430

### SUMMARY OF INVENTION

### Technical Problem

However, there has been a demand for an image pickup apparatus that is capable of obtaining images for high dynamic range imaging with a simpler configuration than those of the conventional technologies described above, or a general configuration.

An embodiment of this application, which is exemplary and is not limitative, provides an image pickup apparatus that is capable of obtaining images for high dynamic range imaging with a simple configuration or a general configuration.

### Solution to Problem

An image pickup apparatus according to the present invention includes: a lens optical system including a first optical region and a second optical region; an image pickup device including at least a plurality of first pixels and a plurality of second pixels where light transmitted through the lens optical system enters; an area segmented optical attenuator device including a first light control part and a second light control part, which are located in the first optical region and the second optical region, respectively; a control section for changing at least one of a transmittance of the first light control part of the area segmented optical attenuator device and a transmittance of the second light control part of the area segmented optical attenuator device; and an array-patterned optical device, which is placed between the lens optical system and the image pickup device, for causing light transmitted through the first optical region to enter the plurality of first pixels and causing light transmitted through the second optical region to enter the plurality of second pixels.

### Advantageous Effects of Invention

The image pickup device according to one aspect of the present invention is capable of obtaining a plurality of images that are taken under different exposure conditions for high dynamic range imaging while using the single-lens optical system. A high dynamic range image is thus obtained in a favorable manner.

### BRIEF DESCRIPTION OF DRAWINGS

FIG. 1 is a diagram illustrating the configuration of an image pickup apparatus according to a first embodiment of the present invention.

FIG. 2(a) and FIG. 2(b) are respectively a sectional view and frontal view of an area segmented optical attenuator device according to the first embodiment.

FIG. 3 is a perspective view of an array-patterned optical device according to the first embodiment.

FIG. 4 is an enlarged sectional view schematically illustrating a region in the vicinity of the array-patterned optical device and image pickup device according to the first embodiment.

FIG. 5 is a frontal view of an area segmented optical attenuator device according to a second embodiment.

FIG. 6 is a perspective view schematically illustrating a region in the vicinity of an array-patterned optical device and image pickup device according to the second embodiment.

FIG. 7 is a diagram illustrating light beams incident on an image pickup surface according to the second embodiment.

FIG. 8 is a diagram illustrating the configuration of a third embodiment.

FIG. 9(a) is a frontal view of an area segmented optical attenuator device according to the third embodiment, and FIG. 9(b) is a frontal view illustrating another example of the area segmented optical attenuator device.

FIG. 10 is a perspective view of an array-patterned optical device according to a fourth embodiment.

FIGS. 11(a) and 11(b) are diagrams illustrating the incidence of a light beam on an image pickup device according to the fourth embodiment.

FIGS. 12(a) and 12(b) are respectively a frontal view and rear view of a digital camera according to an embodiment of the present invention.

FIG. 13 is a block diagram illustrating the configuration of a fifth embodiment.

### DESCRIPTION OF EMBODIMENTS

The inventors of the invention of this application have studied in detail about the generation of a high dynamic range image with conventional image pickup devices. According to the study, a technology of generating a wide dynamic range image by taking a plurality of images under varying exposure conditions cannot be used for the photographing of a mobile subject or the shooting of a video because the plurality of images are obtained at different times. In addition, when photographing even a still object with a camera held in hand, camera shake during the taking of a plurality of images can cause a shift in the position of the photographed subject between the obtained images. Compositing such images by HDR composition means an increased calculation amount, and thus limits conditions for favorable photographing.

The technologies disclosed in Patent Document No. 1 and Patent Document No. 2 also require dedicated image pickup devices and increase initial cost.

With the technology of Patent Document No. 3, a lens optical system is built as a lens array in front of an image pickup region, and the effective radius of a single-lens optical system therefore needs to be less than a half or ¼ of the planar dimensions of the image pickup region. The degree of freedom in optical design is consequently small, which makes it difficult to configure an optical system having a resolution satisfactory for the purpose of obtaining images.

In view of those problems, the inventors of the invention of this application have thought up a novel image pickup apparatus capable of obtaining a plurality of images taken under different exposure conditions for high dynamic range imaging.

An image pickup apparatus according to one aspect of the present invention includes: a lens optical system including a first optical region and a second optical region; an image pickup device including at least a plurality of first pixels and a plurality of second pixels where light transmitted through the lens optical system enters; an area segmented optical attenuator device including a first light control part and a second light control part, which are located in the first optical region and the second optical region, respectively; a control section for changing at least one of a transmittance of the first light control part of the area segmented optical attenuator device and a transmittance of the second light control part of the area segmented optical attenuator device; and an array-patterned optical device, which is placed between the lens optical system and the image pickup device, for causing light transmitted through the first optical region to enter the plurality of first pixels and causing light transmitted through the second optical region to enter the plurality of second pixels.

The image pickup apparatus may further include a signal processing section for generating a high dynamic range image based on signals of the light incident on the plurality of first pixels and signals of the light incident on the plurality of second pixels.

The image pickup device may be a monochrome image pickup device.

The lens optical system may be an image-side telecentric optical system.

The array-patterned optical device may be a lenticular lens.

In the image pickup device, the plurality of first pixels and the plurality of second pixels may be each aligned in a plurality of rows in a first direction, and the plurality of rows of first pixels aligned in the first direction and the plurality of rows of second pixels aligned in the first direction may be arranged alternately in a second direction, which is orthogonal to the first direction, to constitute an image pickup surface.

The lens optical system may further include a third optical region and a fourth optical region, and the area segmented optical attenuator device may further include a third light control part, which is located in the third optical region, and a fourth light control part, which is located in the fourth optical region.

The array-patterned optical device may be a microlens array.

The area segmented optical attenuator device may include at least three transmissive parts, of which adjacent two have different transmittances, and the control section may include a driving mechanism for moving the at least three transmissive parts so that two arbitrary adjacent transmissive parts out of the at least three transmissive parts are located in the first optical region and the second optical region.

The area segmented optical attenuator device may include: a pair of polarizing plates; a common transparent electrode, which is sandwiched between the pair of polarizing plates, and two divided transparent electrodes, which are respectively located in the first optical region and the second optical region; and a liquid crystal layer, which is sandwiched between the common transparent electrode and the two divided transparent electrodes, and the control section may apply different voltages to the two divided transparent electrodes.

In the image pickup apparatus shooting operation may be executed a plurality of times while varying the voltages.

In an image pickup apparatus according to another aspect of the present invention, the plurality of first pixels include a plurality of 1A pixels having a filter that has first spectral transmittance characteristics, a plurality of 2A pixels having a filter that has second spectral transmittance characteristics, a plurality of 3A pixels having a filter that has third spectral transmittance characteristics, and a plurality of 4A pixels having a filter that has fourth spectral transmittance characteristics, the plurality of second pixels include a plurality of 1B pixels having a filter that has the first spectral transmittance characteristics, a plurality of 2B pixels having a filter that has the second spectral transmittance characteristics, a plurality of 3B pixels having a filter that has the third spectral transmittance characteristics, and a plurality of 4B pixels having a filter that has the fourth spectral transmittance characteristics, and the array-patterned optical device includes: a plurality of first optical elements for causing the light transmitted through the first optical region to enter the plurality of 1A pixels and the plurality of 3A pixels, and causing the light transmitted through the second optical region to enter the plurality of 2B pixels and the plurality of 4B pixels; and a plurality of second optical elements for causing the light transmitted through the first optical region to enter the plurality of 2A pixels and the plurality of 4A pixels, and causing the light transmitted through the second optical region to enter the plurality of 1B pixels and the plurality of 3B pixels.

On an image pickup surface of the image pickup device, each of the plurality of 1A pixels, each of the plurality of 2B pixels, each of the plurality of 3A pixels, and each of the plurality of 4B pixels may be placed adjacent to one another at vertices of a square.

The filter that has the first spectral transmittance characteristics and the filter that has the second spectral transmittance characteristics may be filters that transmit light of a green wavelength band, the filter that has the third spectral transmittance characteristics may be a filter that transmits light of a red wavelength band, the filter that has the fourth spectral transmittance characteristics may be a filter that transmits light of a blue wavelength band, and each of the plurality of 1A pixels, each of the plurality of 2B pixels, each of the plurality of 3A pixels, and each of the plurality of 4B pixels may be arranged in a Bayer arrangement pattern.

The plurality of first optical elements and the plurality of second optical elements may each be a lenticular lens.

The lens optical system may further include a stop, and the first optical region and the second optical region may be located near the stop.

An image pickup apparatus according to still another aspect of the present invention includes: a lens optical system including a first optical region and a second optical region; an image pickup device including a plurality of first pixels, a plurality of second pixels, a plurality of third pixels, and a plurality of fourth pixels where light transmitted through the lens optical system enters, the plurality of first pixels having a filter that has first spectral transmittance characteristics, the plurality of second pixels having a filter that has second spectral transmittance characteristics, the plurality of third pixels having a filter that has third spectral transmittance characteristics, the plurality of fourth pixels having a filter that has fourth spectral transmittance characteristics, the plurality of first pixels and the plurality of second pixels being arranged alternately in a first direction in a first row, the plurality of third pixels and the plurality of fourth pixels being arranged alternately in the first direction in a second row, the first row and the second row being arranged alternately in a second direction to form an image pickup surface; an area segmented optical attenuator device including a first light control part and a second light control part, which are located in the first optical region and the second optical region, respectively; a control section for changing at least one of a transmittance of the first light control part of the area segmented optical attenuator device and a transmittance of the second light control part of the area segmented optical attenuator device; and an array-patterned optical device, which is placed between the lens optical system and the image pickup device, in the lens optical system, the first optical region and the second optical region being arranged in the second direction, the array-patterned optical device including a plurality of optical elements for causing the light transmitted through the lens optical system to enter the image pickup surface for each set of four pixels including one of the plurality of first pixels, one of the plurality of second pixels, one of the plurality of third pixels, and one of the plurality of fourth pixels, the four pixels being arranged adjacent to one another in the first direction and the second direction, the plurality of optical elements constituting a plurality of columns arranged linearly in the second direction, of two of the plurality of columns that are adjacent to each other in the first direction, each optical element in one column being staggered from its corresponding optical element in another column by a length half an arrangement cycle of the plurality of optical elements in the second direction.

A camera according to one aspect of the present invention includes: any one of the above-mentioned image pickup apparatus; an image displaying section; a shutter button; and an image saving section.

Image pickup apparatus according to embodiments of the present invention are described below with reference to the drawings.

### First Embodiment

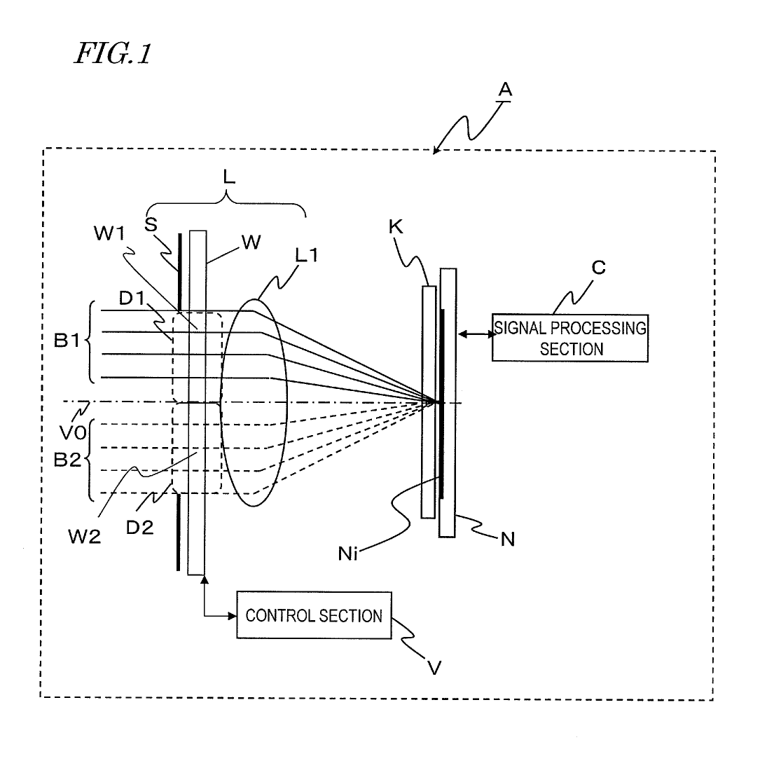

FIG. 1 is a schematic view illustrating an image pickup device according to a first embodiment of the present invention. The image pickup apparatus of this embodiment, which is denoted by A, includes a lens optical system L, which has V0 as an optical axis, an array-patterned optical device K, which is disposed in the vicinity of the focal point of the lens optical system L, an image pickup device N, a signal processing section C, an area segmented optical attenuator device W, and a control section V.

In this embodiment, the lens optical system L includes a stop S and an objective lens L1 for forming an image on the image pickup device with light that has been transmitted through the stop S. The lens optical system L also includes a first optical region D1 and a second optical region D2. The first optical region D1 and the second optical region D2 are located in the vicinity of the stop S. A region that is the first optical region D1 and the second optical region D2 combined is also referred to as a pupil region.

The area segmented optical attenuator device W is a liquid crystal device, and includes a first light control part W1, which is located in the first optical region D1, and a second light control part W2, which is located in the second optical region D2.

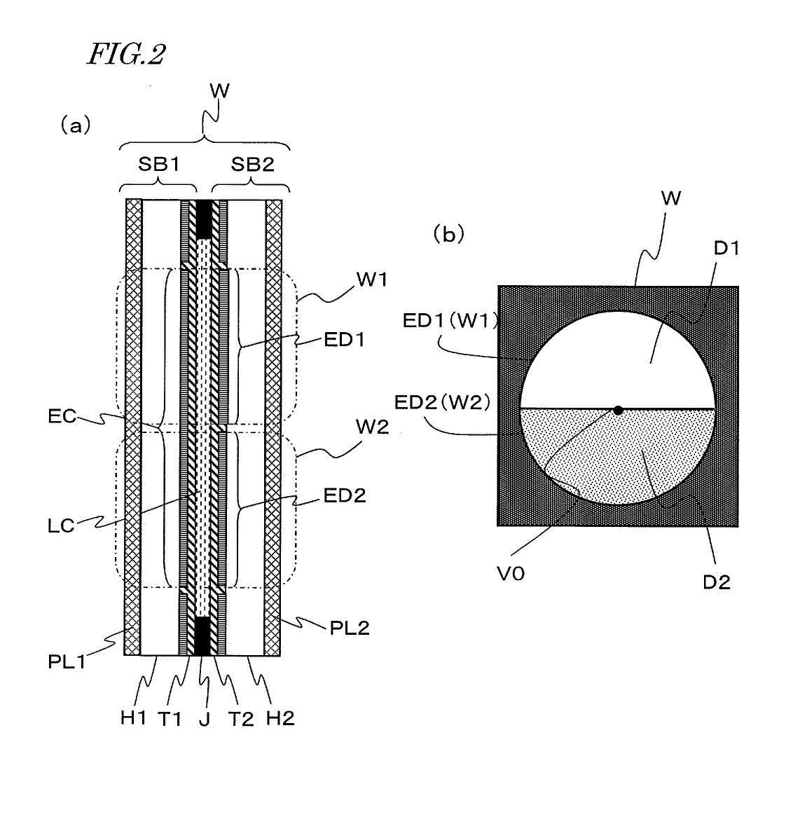

FIG. 2(a) and FIG. 2 (b) are respectively a sectional view and a frontal view that schematically illustrate the structure of the area segmented optical attenuator device W. The area segmented optical attenuator device W includes a common transparent electrode EC, a liquid crystal layer LC, divided transparent electrodes ED1 and ED2, and polarizing plates PL1 and PL2.

The common transparent electrode EC is provided on one side of a glass substrate H1, and is covered with an alignment film T1. The polarizing plate PL1 is disposed on the other side of the glass substrate H1. These constitute a substrate SB1. The divided transparent electrodes ED1 and ED2 are provided on one side of a glass substrate H2 and are covered with an alignment film T2. The polarizing plate PL2 is disposed on the other side of the glass substrate H2. The polarizing plate PL1 and the polarizing plate PL2 each have a polarization axis and transmit light that vibrates in the direction of the polarization axis. For example, the alignment directions of the alignment film T1 and the alignment film T2 match the polarization axis directions of the polarizing plate PL1 and the polarizing plate PL2, respectively. The substrate SB1 and the substrate SB2 are bonded to each other with a sealing material J so that, for example, the polarization axis of the polarizing plate PL1 and the polarization axis of the polarizing plate PL2 are orthogonal to each other. The liquid crystal layer LC is held in a space formed by the sealing material, the substrate SB1, and the substrate SB2.

As illustrated in FIG. 2(b), the divided transparent electrodes ED1 and ED2 are arranged so that the border between the divided transparent electrodes ED1 and ED2 coincides with a horizontal direction that runs across the optical axis V0 of the lens optical system L. The common transparent electrode EC, the divided transparent electrode ED1, and a portion of the liquid crystal layer LC that is sandwiched therebetween constitute the first light control part W1, which is located in the first optical region D1. The common transparent electrode EC, the divided transparent electrode ED2, and a portion of the liquid crystal layer LC that is sandwiched therebetween constitute the second light control part W2, which is located in the second optical region D2.

The liquid crystal layer LC has optical rotatory power and exhibits a degree of optical rotation that is determined by a voltage applied between the common transparent electrode EC and the divided transparent electrodes ED1 and ED2. Accordingly, when different voltages are applied to the divided transparent electrodes ED1 and ED2, the portion of the liquid crystal layer LC that is sandwiched between the common transparent electrode EC and the divided transparent electrode ED1 and the portion of the liquid crystal layer LC that is sandwiched between the common transparent electrode EC and the divided transparent electrode ED2 exhibit different degrees of optical rotation.

Out of a light beam incident on the liquid crystal device (the area segmented optical attenuator device W), only a component that vibrates in a direction parallel to the polarization axis of the polarizing plate PL1 is transmitted through the liquid crystal layer LC. The polarization direction of the light beam incident on the liquid crystal layer LC is rotated due to the optical rotatory power of the liquid crystal layer LC and then enters the polarizing plate PL2. Out of the light transmitted through the liquid crystal layer LC, the polarizing plate PL2 transmits only a component that vibrates in a direction parallel to the polarization axis of the polarizing plate PL2.

The proportion of the component parallel to the polarization axis of the polarizing plate PL2 to the light transmitted to the polarizing plate PL1 can be changed by changing the value of a voltage applied by the control section V and thereby changing the optical rotatory power of the liquid crystal layer LC. The transmittances of the first light control part W1 and the second light control part W2 in the liquid crystal device (the area segmented optical attenuator device W) can therefore be changed independently of each other with the use of the voltage applied by the control section V. In this embodiment, the control section V applies different voltages to the divided transparent electrodes ED1 and ED2 and thereby controls the liquid crystal device (the area segmented optical attenuator device W) so that the transmittance of the first light control part W1 differs from the transmittance of the second light control part W2.

For example, in the case where voltages are applied to the divided transparent electrodes ED1 and ED2 so that the liquid crystal layer LC is given an optical rotatory power that causes the polarization axis to rotate by 90 degrees, the polarizing plate PL2 transmits the entirety of the light transmitted through the polarizing plate PL1 because the polarization axis of the polarizing plate PL1 and the polarization axis of the polarizing plate PL2 are orthogonal to each other. The proportion of light transmitted through the polarizing plate PL2 to the light transmitted through the polarizing plate PL1 is ideally 100% in this case. In the case where voltages are applied to the divided transparent electrodes ED1 and ED2 so that the liquid crystal layer LC is given an optical rotatory power that causes the polarization axis to rotate by 0 degree or 180 degrees, the polarizing plate PL2 transmits none of the light transmitted through the polarizing plate PL1. The proportion of light transmitted through the polarizing plate PL2 to the light transmitted through the polarizing plate PL1 is ideally 0% in this case. When the polarization axis is rotated between these angles, the proportion of light transmitted through the polarizing plate PL2 to the light transmitted through the polarizing plate PL1 takes a value between 0% and 100%.

The actual transmittances of the first light control part W2 and the second light control part W2 in the liquid crystal device (the area segmented optical attenuator device W) are values that take into account the proportion of light transmitted through the polarizing plate PL1 and light absorption by elements that constitute the liquid crystal device (the area segmented optical attenuator device W).

As illustrated in FIG. 1, out of light incident on the stop S, a light beam B1 enters the first light control part W1 of the area segmented optical attenuator device W which is located in the first optical region D1, and a light beam B2 enters the second light control part W2 of the area segmented optical attenuator device W which is located in the first optical region D1. Because the first light control part W1 and the second light control part W2 have different transmittances, the light beams B1 and B2 transmitted through the area segmented optical attenuator device W differ from each other in light amount (light beam intensity). The light beam B1 and the light beam B2 are converged by the objective lens L1, and the converged light enters the array-patterned optical device K.

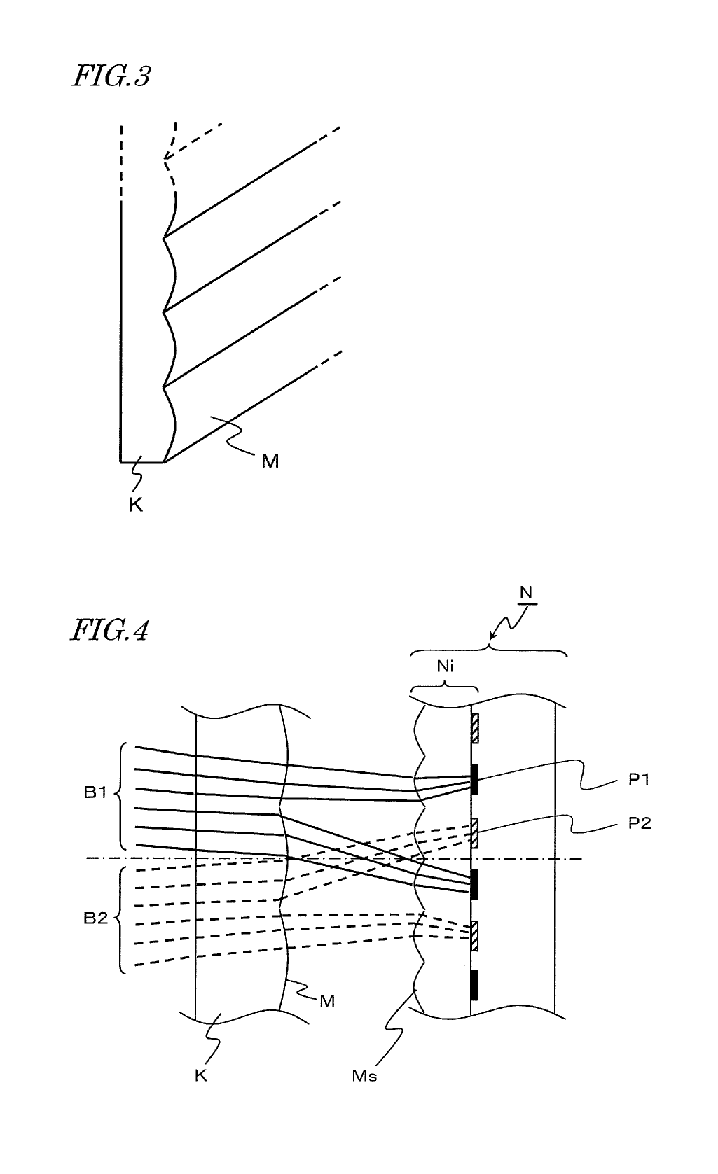

FIG. 3 is a perspective view of the array-patterned optical device K. The array-patterned optical device K includes a plurality of optical elements M each of which has a lens surface. The lens surface of each optical element M is a cylindrical surface in this embodiment. The plurality of optical elements M are arranged along a vertical direction in the array-patterned optical device K so that the cylindrical surfaces stretch in a horizontal direction. The plurality of optical elements M constitute a lenticular lens in this manner.

FIG. 4 is an enlarged view of the array-patterned optical device K and image pickup device N of FIG. 1. The array-patterned optical device K which is a lenticular lens is disposed with the side where the optical elements M are formed facing the image pickup device N. As illustrated in FIG. 1, the array-patterned optical device K is placed in the vicinity of the focal point of the lens optical system L, at a point a given distance from the image pickup device N.

The image pickup device N includes a plurality of first pixels P1 and a plurality of second pixels P2 which are arranged on an image pickup surface Ni. The plurality of first pixels P1 and the plurality of second pixels P2 are each arranged in a plurality of rows in a horizontal direction (a first direction), and are arranged alternately in a vertical direction (a second direction) as illustrated in FIG. 4.

The plurality of first pixels P1 and the plurality of second pixels P2 in this embodiment have the same shape on the image pickup surface Ni. For instance, the plurality of first pixels P1 and the plurality of second pixels P2 have the same rectangular shape and equal planar dimensions.

The image pickup device N may include a plurality of microlenses Ms provided on the image pickup surface Ni so as to cover the surface of each pixel. The placement of the array-patterned optical device K is determined with the focal point of the objective lens L1 as a reference. The cycle of the cylindrical surfaces of the array-patterned optical device K in the vertical direction is matches a cycle corresponding to two of pixels formed on the image pickup surface Ni.

As illustrated in FIG. 4, the border between two adjacent cylindrical surfaces of the array-patterned optical device K is flush with the border between two adjacent microlenses Ms of the image pickup device N in the horizontal direction. In other words, the image pickup device N is arranged so that one of the optical elements M of the array-patterned optical device K corresponds to two rows of pixels on the image pickup surface Ni. The optical elements M have a function of allocating a light beam an exit direction based on the incident angle of the light beam. Specifically, the function causes most of the light beam B1 transmitted through the first optical region D1 to enter the first pixels P1 on the image pickup surface Ni and causes most of the light beam B2 transmitted through the second optical region D2 to enter the second pixels P2 on the image pickup surface Ni. This is accomplished by adjusting the refraction index of the lenticular lens used as the array-patterned optical device K, the radius of curvature of the optical elements M, the distance of the optical elements M from the image pickup surface Ni, and the like.

The image pickup device N converts incident light by photoelectric conversion and outputs an image signal Q0 to the signal processing section C. The signal processing section C generates from the image signal Q0 an image signal Q1 via the first pixels P1 and an image signal Q2 via the second pixels P2.

The image signal Q1 forms an image generated from a light beam that has been transmitted through the first optical region D1, and the second image signal Q2 forms an image generated from a light beam that has been transmitted through the second optical region D2. For the reason described above, the first light control part W1 located in the first optical region D1 and the second light control part W2 located in the second optical region D2 differ from each other in transmittance. This means that an image formed from the image signal Q1 and an image formed from the image signal Q2 are taken under different exposure conditions. By performing various types of known image processing on two image signals of different exposure conditions, high dynamic range imaging can be executed.

The thus obtained two images are taken at once by the single-lens optical system. Accordingly, the same subject is photographed from the same angle at substantially the same time in the two images, and there is no difference between the two images except for the different exposure conditions. In addition, the two images have the same resolution because the exposure condition is varied for the two images by adjusting the light beam transmittance, instead of varying the planar dimensions of the stop, and high dynamic range imaging can be executed favorably.

Thus, according to this embodiment, the light transmittance can be varied for the first optical region D1 and the second optical region D2 by adjusting voltages that are applied to the divided transparent electrode ED1 and the divided transparent electrode ED2. The exposure condition of an image to be obtained can therefore be adjusted suitably depending on the shooting environment.

In addition, because the transmittance of the area segmented optical attenuator device can be adjusted without using a mechanical driving part, high-speed, stable light control operation is accomplished. This enables the image pickup apparatus to photograph under a given condition and then photograph again in a short period of time and even under a different exposure condition. For instance, when photographing a living body under three or more different exposure conditions, as many images as the shooting count multiplied by 2 can be obtained by photographing a plurality of times at short intervals.

The lens optical system L of this embodiment may be an image-side telecentric optical system. This way, the incident angle of the principal light of a light beam that enters at a different field angle can be made close to 0 degrees with respect to the array-patterned optical device K. Cross talk (a phenomenon in which light intended to enter the first pixels P1 enters the second pixels P2 or light intended to enter the second pixels P2 enters the first pixels P1) can be prevented over the entire region of the image pickup device.

The stop S is a region through which light fluxes of all field angles pass. Therefore, by inserting a surface that has optical characteristics capable of controlling transmittance characteristics in the vicinity of the stop S, the transmittance and polarization characteristics of a light flux of all field angles can be controlled in a similar manner. In short, the area segmented optical attenuator device W may be provided in the vicinity of the stop S in this embodiment. With the area segmented optical attenuator device W placed in the optical regions D1 and D2 which are located in the vicinity of the stop, a light flux can be given transmittance characteristics that are suited to the count of regions created by division.

In FIG. 1, the area segmented optical attenuator device W is positioned so that light that has passed through the stop S directly (without the intervention of another optical member) enters the area segmented optical attenuator device W. The area segmented optical attenuator device W may be provided nearer to the subject side than the stop S. In this case, light that has passed through the area segmented optical attenuator device W may directly (without the intervention of another optical member) enter the stop S. In the case of an image-side telecentric optical system, the incident angle of a light beam at the focal point of the optical system is determined uniquely by the position at which the light beam passes through the stop S. In addition, because the array-patterned optical device K has a function of allocating a light beam an exit direction based on the incident angle of the light beam, a light flux can be distributed among pixels on the image pickup surface Ni so as to correspond to the optical regions D1 and D2 divided in the vicinity of the stop S.

In the case of an image-side non-telecentric optical system, the incident angle of a light beam at the focal point of the optical system is determined uniquely by the position and the field angle at which the light beam passes through the stop S.

### Second Embodiment

An image pickup apparatus according to a second embodiment of the present invention is described. The image pickup apparatus of this embodiment differs from the image pickup apparatus of the first embodiment in that: the lens optical system includes first to fourth optical regions; the area segmented optical attenuator device includes four light control parts; and that microlenses are included as the array-patterned optical device. The description focuses mainly on these differences from the first embodiment.

The lens system L in this embodiment includes a first optical region, a second optical region, a third optical region, and a fourth optical region. FIG. 5 illustrates an example of divided transparent electrodes of the area segmented optical attenuator device W which are disposed in these four optical regions. The area segmented optical attenuator device W in FIG. 5 is viewed from the object side. The area segmented optical attenuator device W includes a first light control part W1, a second light control part W2, a third light control part W3, and a fourth light control part W4 which are located in the first optical region denoted by D1, the second optical region denoted by D2, the third optical region denoted by D3, and the fourth optical region denoted by D4, respectively. The first light control part W1, the second light control part W2, the third light control part W3, and the fourth light control part W4 include a divided transparent electrode ED1, a divided transparent electrode ED2, a divided transparent electrode ED3, and a divided transparent electrode ED4, respectively. The control section V adjusts voltages applied to the divided transparent electrodes ED1 to ED4, to thereby vary the light transmittance among the light control parts disposed in the optical regions.

The border between the first optical region D1 and the second optical region D2 and the border between the third optical region D3 and the fourth optical region D4 are located, for example, on a plane parallel to a horizontal direction of the image pickup apparatus that includes the optical axis V0 of the lens optical system L. The border between the first optical region D1 and the fourth optical region D4 and the border between the second optical region D2 and the fourth optical region D4 are located, for example, on a plane parallel to a vertical direction of the image pickup apparatus that includes the optical axis V0 of the lens optical system L.

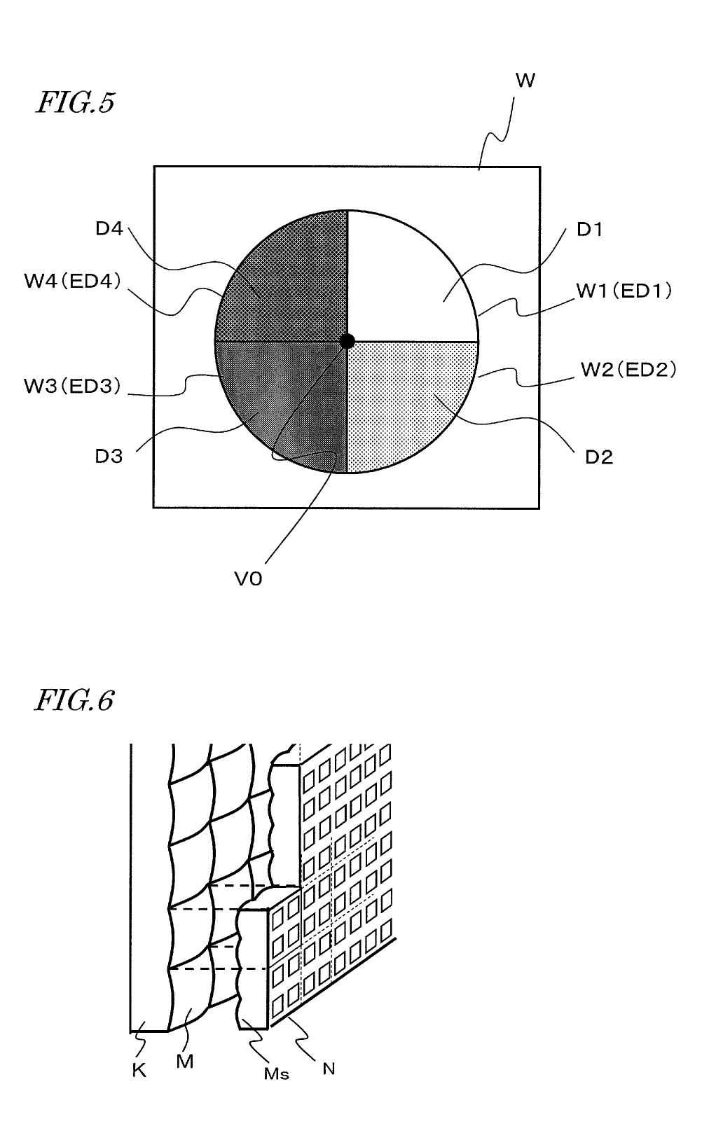

FIG. 6 is a cutaway perspective view illustrating a portion of the array-patterned optical device K and the image pickup device N. In this embodiment, the optical elements M of the array-patterned optical device K are microlenses and the lens surfaces are spherical surfaces. The optical elements M are arranged cyclically in the horizontal direction and the vertical direction to constitute a microlens array. The image pickup device N is arranged so as to be opposed to the array-patterned optical device K, and the microlenses Ms are provided in respective pixels on the image pickup surface Ni of the image pickup device N. The cycle of the optical elements M of the array-patterned optical device K is twice the cycle of the microlenses Ms of the image pickup device N in the horizontal direction and the vertical direction both. Four pixels on the image pickup surface Ni accordingly correspond to one optical element M of the microlens array that constitutes the array-patterned optical device K.

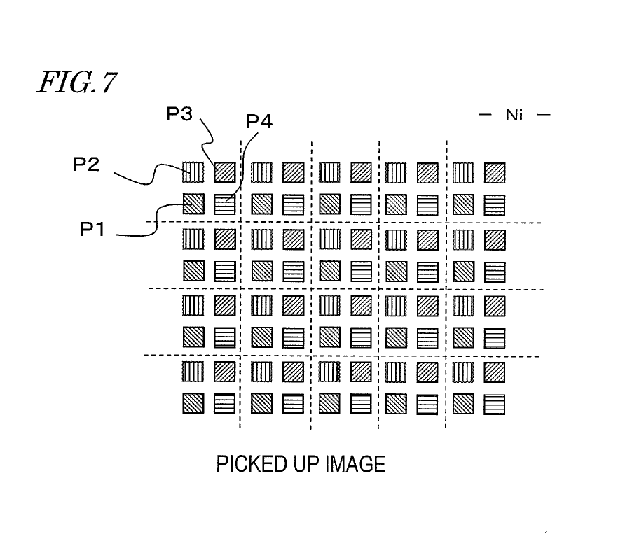

FIG. 7 illustrates a relation between pixels arranged on the image pickup surface of the image pickup device N and light beams that have passed through the four optical regions of the lens optical system L. The image pickup device N includes a plurality of first pixels P1, a plurality of second pixels P2, a plurality of third pixels P3, and a plurality of fourth pixels P4 which are arranged on the image pickup surface Ni. As illustrated in FIG. 7, the second pixels P2 and the third pixels P3 are arranged alternately in the horizontal direction and the first pixels P1 and the fourth pixels P4 are arranged alternately in the horizontal direction on the image pickup surface Ni. Rows in which the second pixels P2 and the third pixels P3 are aligned and rows in which the first pixels P1 and the fourth pixels P4 are aligned are arranged alternately so that the first pixels P1 are adjacent to the second pixels P2 in the vertical direction. Accordingly, one first pixel P1, one second pixel P2, one third pixel P3, and one fourth pixel P4 are disposed adjacent to one another in the row direction and the column direction, and correspond to one optical element M of the microlens array.

A light beam transmitted through the first light control part W1 in the first optical region D1 is converged by the lens optical system L, and the optical elements M of the array-patterned optical device K causes the converged light to enter the first pixels P1. Similarly, a light beam transmitted through the second light control part W2 in the second optical region D2, a light beam transmitted through the third light control part W3 in the third optical region D3, and a light beam transmitted through the fourth light control part W4 in the fourth optical region D4 enter the second pixels P2, the third pixels P3, and the fourth pixels P4, respectively. In other words, in each optical region, a light beam transmitted through the optical region enters pixels of the same type which are located in every other spot in the horizontal direction and the vertical direction on the image pickup surface Ni.

The image pickup device N converts incident light by photoelectric conversion for each pixel, and outputs the resultant signal to the signal processing section C. The signal processing section C processes signals obtained from the first pixels P1, signals obtained from the second pixels P2, signals obtained from the third pixels P3, and signals obtained from the fourth pixels P4 separately from one another to generate an image signal for the first pixels P1, the second pixels P2, the third pixels P3, and the fourth pixels P4 each. Specifically, the signal processing section C processes signals obtained from the plurality of first pixels P1, to thereby generate an image signal Q1. An image signal Q2, an image signal Q3, and an image signal Q4 are generated similarly by processing signals obtained from the plurality of second pixels P2, signals obtained from the plurality of third pixels P3, and signals obtained from the plurality of fourth pixels P4, respectively.

The thus obtained image signals Q1, Q2, Q3, and Q4 respectively form an image 1, image 2, image 3, and image 4 of the same scene photographed at the same time with a single lens system. The image 1, the image 2, the image 3, and the image 4, however, are photographed under different exposure conditions. Therefore, according to this embodiment, the same image can be taken under many exposure conditions where the light amount is varied, and a photographed image that has no whiteout area and no blackout area throughout from the light portion to the dark portion can be obtained by HDR processing in a wide brightness range.

### Third Embodiment

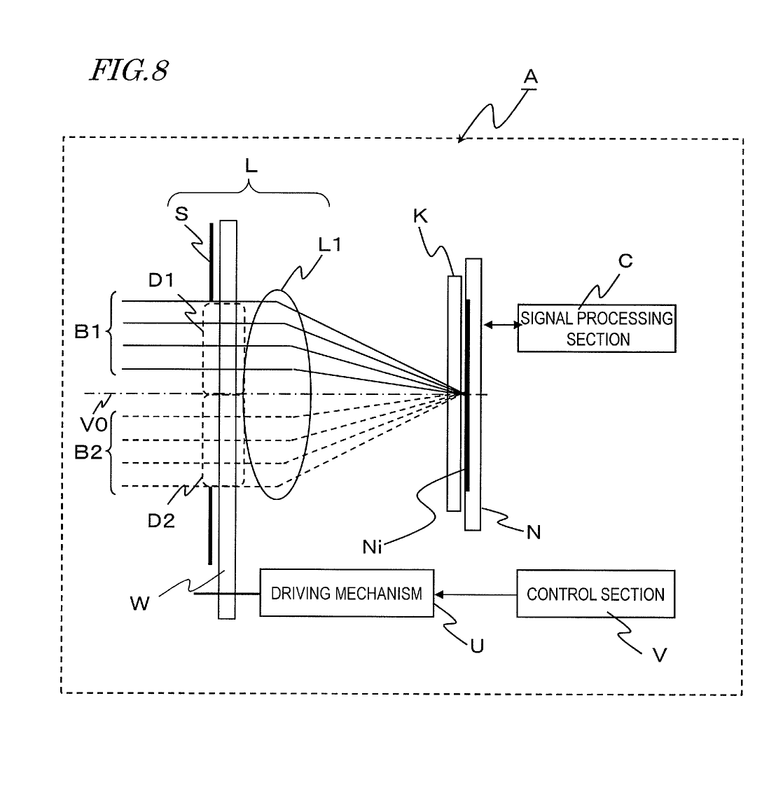

An image pickup apparatus according to a third embodiment of the present invention is described. FIG. 8 is a schematic view illustrating the image pickup apparatus of this embodiment. The image pickup apparatus of this embodiment differs from the image pickup apparatus of the first embodiment in that the area segmented optical attenuator device W is of a switching type, that a driving mechanism U of the area segmented optical attenuator device W is included, and that the control section V controls the operation of the driving mechanism U. The description focuses mainly on these differences from the first embodiment.

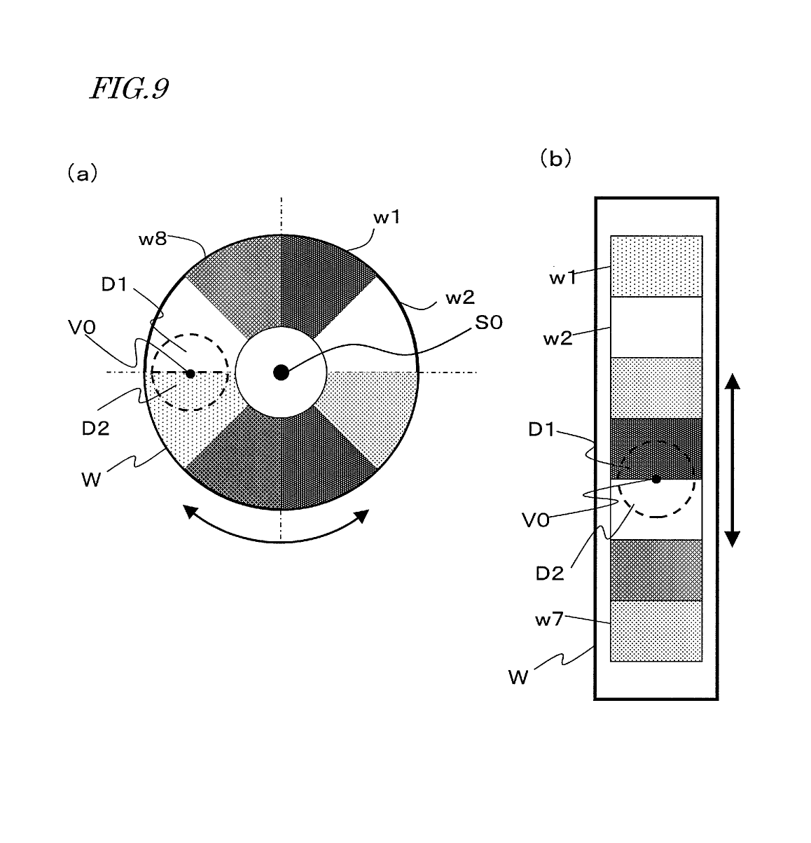

The switching-type area segmented optical attenuator device W of this embodiment includes at least three transmissive parts, and every two adjacent transmissive parts have different transmittances. FIG. 9(a) illustrates an example of the area segmented optical attenuator device W. The area segmented optical attenuator device W of FIG. 9(a) has eight fan-shaped transmissive parts, namely, a first transmissive part w1 to an eighth transmissive part w8, which are arranged around a rotation center S0. For example, at least adjacent transmissive parts among the first to eighth transmissive parts w1 to w8 differ from each other in transmittance with the border between adjacent transmissive parts as a reference. The first to eighth transmissive parts w1 to w8 can be built from, for example, ND filters having different transmittances.

The driving mechanism U rotates the area segmented optical attenuator device W about the rotation center S0 based on a signal from the control section V, and stops the rotation of the area segmented optical attenuator device W at a point where the border between adjacent transmissive parts overlaps with the optical axis V0 of the lens optical system L. This puts two transmissive parts different from each other in the optical transmittance in the first optical region D1 and the second optical region D2, thereby enabling the transmissive parts that are located in the first optical region D1 and the second optical region D2 to function as the first light control part W1 and the second light control part W2. In addition, because transmissive parts to be placed in the first optical region D1 and the second optical region D2 can be selected from the first to eighth transmissive parts w1 to w8, the transmittances of the first light control part W1 and the second light control part W2 can be selected arbitrarily from given combinations.

With this configuration, the optical transmittance of the first optical region D1 and the second optical region D2 can be switched by selecting light control parts suitable for conditions under which a subject is photographed, and light-controlled images adapted for a broader shooting environment can be taken.

The switching-type area segmented optical attenuator device W is not limited to the configuration of FIG. 9(a), and various modifications can be made thereto. For instance, a first transmissive part w1 to a seventh transmissive part W7 may be arranged linearly and moved along the direction of the arrangement by the driving mechanism U as illustrated in FIG. 9(b).

### Fourth Embodiment

An image pickup apparatus according to a fourth embodiment of the present invention is described. The image pickup apparatus of this embodiment differs from the image pickup apparatus of the first embodiment in that a color image pickup device having a pixel arrangement in which color filters are arranged by the Bayer arrangement is used as the image pickup device, and that the array-patterned optical device K is a lenticular lens shaped differently from the lenticular lens shape of the first embodiment. The description focuses mainly on these differences from the first embodiment.

In the color image pickup device having the Bayer arrangement, pixels are arranged in a tetragonal lattice pattern, and pixels having a green color filter (first spectral transmission characteristics and second spectral transmission characteristics) are arranged adjacent to one another in an oblique direction at a density of substantially 50% of all pixels. Pixels having a red color filter and pixels having a blue color filter (third spectral transmission characteristics and fourth spectral transmission characteristics) are each arranged evenly at a density of 50% of that of green pixels. More specifically, green pixels are found in each row and each column (odd column, even column, odd row, and even row), whereas red pixels and blue pixels are each found in only odd columns or even columns, and in odd rows or even rows. Therefore, in the case where the array-patterned optical device K has the same structure as the one in the first embodiment (i.e., in the case of a lenticular lens), one of an image that is formed by a light beam transmitted through the first optical region D1 and an image that is formed by a light beam transmitted through the second optical region D2 lacks blue information, and the other lacks red information.

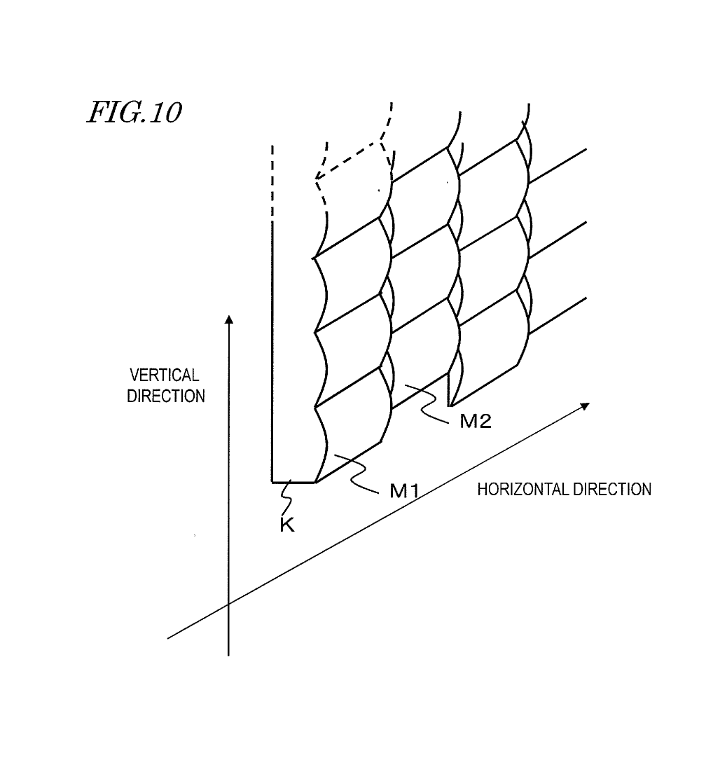

In this embodiment, contrivances are made with respect to the shape of the array-patterned optical device K in order to obtain the same effect as those of the first embodiment also when the color image pickup device having the Bayer arrangement is used. FIG. 10 is a perspective view of the array-patterned optical device K of this embodiment that is viewed from the image side. The array-patterned optical device K includes, as optical elements, a plurality of optical elements M1 and M2 which are cylindrical lenses stretching in a horizontal direction (first direction) and arranged linearly in a vertical direction (second direction). The plurality of optical elements M1 and the plurality of optical elements M2 each constitute columns that stretch in the vertical direction, and columns of optical elements M1 and columns of optical elements M2 are arranged alternately in the horizontal direction. Each optical element in one of a column of optical elements M1 and a column of optical elements M2, which are adjacent to each other in the horizontal direction, is staggered from its corresponding optical element in the other column in the vertical direction by a length half the cycle of arrangement in the vertical direction.

Each optical element M1 corresponds to four pixels having a red filter, a blue filter, and a green filter and arranged by the Bayer arrangement which constitute the image pickup surface of the image pickup device, and causes light transmitted through the lens optical system L to enter its corresponding four pixels. The same applies to each optical element M2. In other words, in each optical element M1 or M2, a cylindrical surface that is the lens surface of the optical element has a cycle of two pixels of the image pickup device N in the vertical direction and the horizontal direction. Accordingly, in two horizontally adjacent columns of optical elements M1 and in two horizontally adjacent columns of optical elements M2, each optical element in one of the columns is staggered from its corresponding optical element in the other column by the length of one pixel in the vertical direction.

As in the first embodiment, a light beam transmitted through the first optical region D1 and a light beam transmitted through the second optical region D2 enter pixels different from each other due to the action of the lenticular lens which is the optical elements M1 and M2. Because the optical elements are staggered by half a cycle in the vertical direction between one column of optical elements M1 and one column of optical elements M2, a light beam from the first optical region D1 and a light beam from the second optical region D2 each enter pixels of the image pickup device while switching between an odd row and an even row for every two pixels.

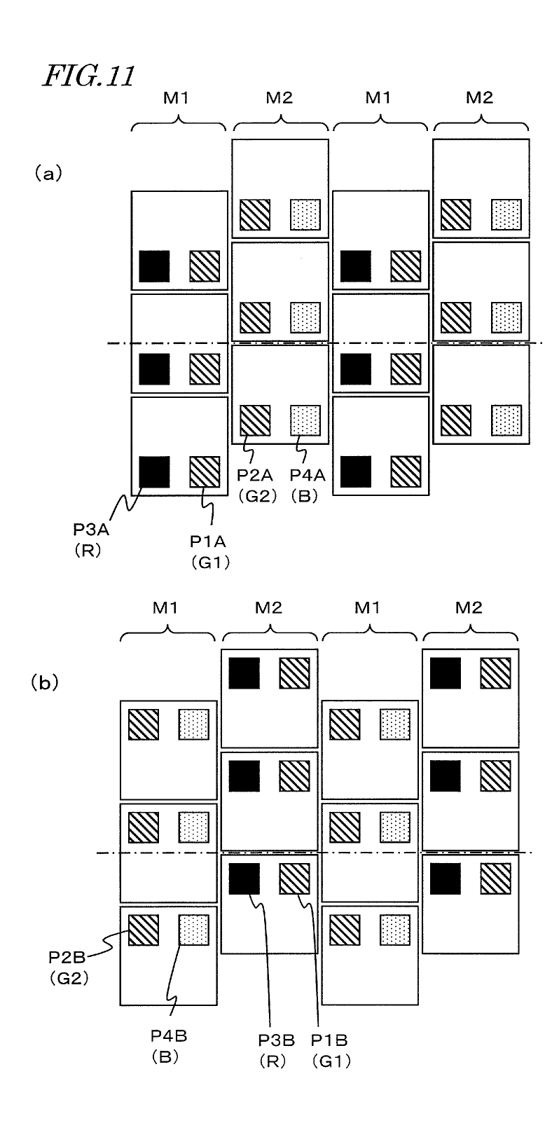

FIG. 11(a) and FIG. 11(b) are schematic views illustrating light incident on the image pickup surface Ni of the image pickup device N in this embodiment. For easier understanding, FIG. 11(a) illustrates pixels to which a light beam transmitted through the first optical region D1 is led and FIG. 11(b) illustrates pixels to which a light beam transmitted through the second optical region D2 is led.

As illustrated in these figures, the optical elements M1 in columns of optical elements M1 lead a light beam from the first optical region D1 to green (G1) pixels P1A and red (R) pixels P3A, and lead a light beam from the second optical region D2 to green (G2) pixels P2B and blue (B) pixels P4B. The optical elements M2 in columns of optical elements M2 lead a light beam from the first optical region D1 to green (G2) pixels P2A and blue (B) pixels P4A, and lead a light beam from the second optical region D2 to green (G1) pixels P1B and red (R) pixels P3B.

The signal processing section C sorts signals from the image pickup device N into signals of pixels where a light beam from the first optical region D1 has entered (FIG. 11(a)) and signals of pixels where a light beam from the second optical region D2 has entered (FIG. 11(b)), and processes the sorted signals separately, thereby form an image from the former signals and an image from the latter signals. Signals of pixels where a light beam from the first optical region D1 has entered (FIG. 11(a)) and signals of pixels where a light beam from the second optical region D2 has entered (FIG. 11(b)) each include signals from red pixels, signals from blue pixels, and signals from green pixels. Two color images of different exposure conditions are thus obtained. As a result, an excellent composite image is generated by high dynamic range imaging.

As is understood from FIG. 11(a) and FIG. 11(b), pixels where a light beam from the first optical region D1 has entered (FIG. 11(a)) do not include green (G2) pixels P2A and blue (B) pixels P4A when the light beam is one led by the optical elements M1. Similarly, a light beam led by columns of optical elements M2 do not enter green (G1) pixels P1A and red (R) pixels P3A. When processing signals of pixels where a light beam from the first optical region D1 has entered (FIG. 11(a)), the signal processing section C may use signals of pixels in an adjacent column of optical elements M2 to interpolate signals of the lacking pixels out of each set of four pixels in a column of optical elements M1. Similarly, when processing signals of pixels where a light beam from the second optical region D2 has entered (FIG. 11(b)), the signal processing section C may use signals of pixels in an adjacent column of optical elements M2 to interpolate signals of the lacking pixels out of each set of four pixels in a column of optical elements M1.

While the image pickup device in this embodiment is a color image pickup device having the Bayer arrangement, pixels that have a green filter out of each set of four pixels may be adjacent to each other in the vertical direction, for example. The image pickup device, which includes pixels having a red filter, pixels having a blue filter, and pixels having a green filter here, may include pixels having filters of colors complementary to red, blue, and green, instead of these colors. Each set of four pixels of the image pickup device may also have filters in other combinations of colors, such as a combination of red, blue, green, and white, or a combination of red, blue, green, and yellow.

### Fifth Embodiment

A digital camera according to an embodiment of the present invention is described.

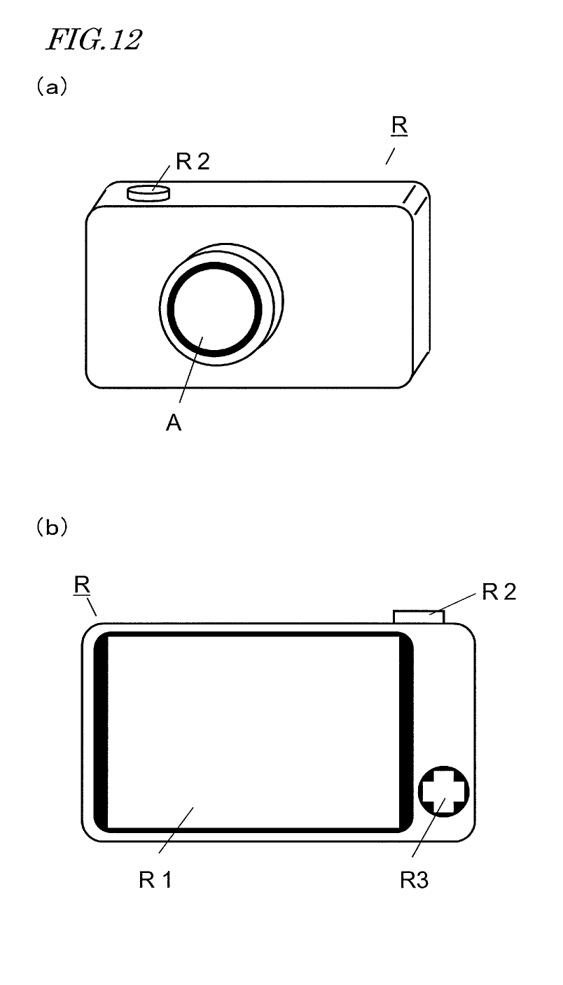

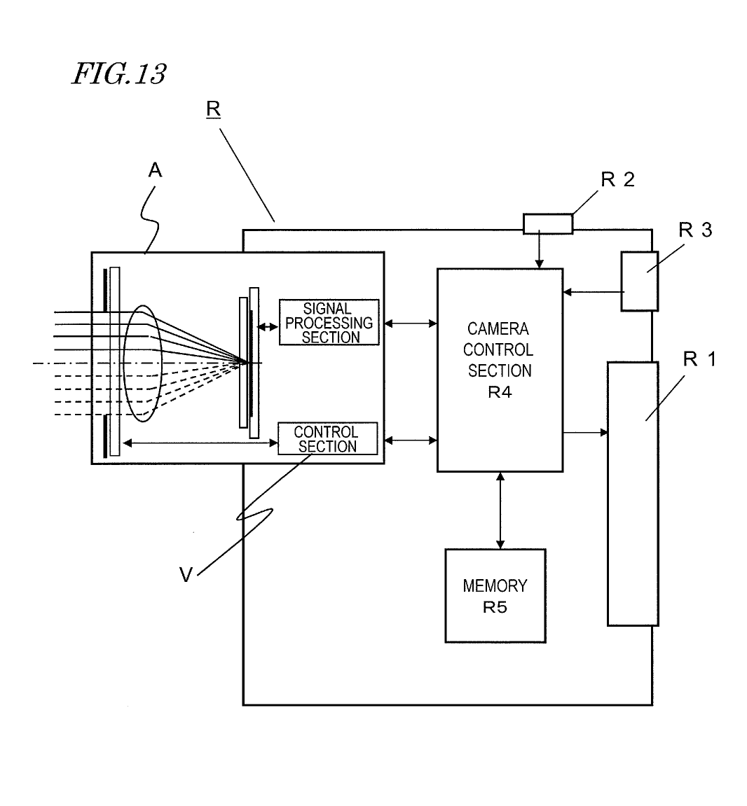

FIG. 12(a) and FIG. 12(b) are a frontal view and a rear view that illustrate a digital camera according to an embodiment of the present invention. The digital camera of FIG. 12(a) and FIG. 12(b) which is denoted by R includes an image pickup apparatus A, an image displaying section R1, a shutter button R2, a main body operating button R3, a camera control section R4 (not shown), and a memory R5 (not shown).

FIG. 13 is a block diagram illustrating the internal configuration of the digital camera R of FIG. 12. The image pickup apparatus A, which can be any one of the image pickup apparatus of the first to fourth embodiments, is the image pickup apparatus of the first embodiment in FIG. 13.

The photographer operates the main body operating button R3 to set settings for high dynamic range shooting. In response to this, the camera control section R4 sends signals to the control section V of the image pickup apparatus A, and adjusts the transmittances of the first optical region D1 and the second optical region D2 through the operation described in the first embodiment.

With the press of the shutter button R2, the camera control section R4 obtains photographed images Q1 and Q2 of different exposure conditions from the signal processing section C of the image pickup apparatus A. The camera control section R4 uses the obtained images Q1 and Q2 to generate a high dynamic range image Q′.

The camera control section R4 transfers the generated high dynamic range image Q′ to the memory R5, which is an image saving section, and also displays the generated image on the image displaying section R1.

The photographer checks the image displayed on the image displaying section R1 and uses the main body operating button R3 to give an instruction such as saving or deleting the photographed image, or setting shooting conditions anew.

According to this embodiment, a digital camera capable of obtaining the high dynamic range image Q is realized.

The camera control section R4 and the signal processing section C and control section V of the image pickup device A are separate configurations in this embodiment. These functions may be implemented by one information processing section.

The memory R5 is built inside the main body of the digital camera in this embodiment, but the digital camera is not limited thereto. The digital camera may have wired or wireless communication means instead of a memory so that the high dynamic range image Q is transmitted and saved in the transmission destination.

Although the description of this embodiment takes a digital camera as an example, a video camera, a cellular phone, a portable information terminal, and the like can be realized with a configuration similar to that of this embodiment.

### Other Embodiments

The lens optical system L which is a single lens in the embodiments described above may include a group lens which is made up of a plurality of lenses. Using a group lens increases the degree of freedom in optical design, and the resultant advantage is that a high-resolution image is obtained.

In order for the array-patterned optical device to accomplish excellent beam division, the lens optical system may have telecentricity on the image side. However, an excellent beam division effect can be exerted also when the lens optical system does not have telecentricity on the image side by suitably adjusting the cycle of the array-patterned optical device which is a lenticular lens, microlens array, or the like placed in front of the image pickup device, depending on the exit angle of the off-axis principal light of the lens optical system.

The light transmittance does not need to be uniform in light control parts of the area segmented optical attenuator device. Specifically, the amount of light in a given wavelength range may vary from one light control part to another. This is effective in a shooting situation where light in the given wavelength range is particularly intense, or a shooting situation where light in the given wavelength range is weak compared to light in other wavelength ranges.

A light control device that uses an electrochromic (EC) effect may be employed as the area segmented optical attenuator device. A light control device using an electrochromic effect is capable of varying the transmittance through voltage application, and therefore has the same effects as those of the liquid crystal device described in the first embodiment.

The area segmented optical attenuator device does not need to have its light control function in every region created by division, and can exert the function described in this application by having the light control function in at least one region.

The signal processing section C which is included in the image pickup apparatus of the embodiments may not be included in an image pickup apparatus of the present invention. In this case, an output signal from the image pickup device may be transmitted to an external apparatus such as a personal computer so that computing performed by the signal processing section C is executed by the external apparatus. In other words, the present invention may be carried out by a system including an image pickup apparatus that includes the lens optical system L, the array-patterned optical device K, and the image pickup device N, and an external signal processing apparatus.

### INDUSTRIAL APPLICABILITY

The image pickup apparatus disclosed in this application can be used favorably as image pickup apparatus for use in digital still cameras, digital video cameras, portable information terminals, and the like, and as image pickup apparatus of monitoring cameras, image input cameras of robots or the like, and industrial cameras such as vehicle-mounted cameras.

### REFERENCE SIGNS LIST

A image pickup apparatus
L lens optical system
L1 objective lens
V0 optical axis
D1, D2, D3, D4 first, second, third, and fourth optical regions
S stop
W area segmented optical attenuator device
K array-patterned optical device
M, M1, M2 optical element
N image pickup device
Ni image pickup surface
Ms microlens
C signal processing section
V control section
U driving mechanism
EC common transparent electrode
ED1, ED2, ED3, ED4 divided transparent electrode
LC liquid crystal layer
PL1, PL2 polarizing plate
SB1, SB2 substrate
H1, H2 glass substrate
J sealing material
T1, T2 alignment film
P1-P4 pixel
P1A-P4A pixel
P1B-P4B pixel
R digital camera
R1 image displaying section
R2 shutter button
R3 main body operating button
R4 camera control section

1. An image pickup apparatus, comprising:
a lens optical system comprising a first optical region and a second optical region;
an image pickup device comprising at least a plurality of first pixels and a plurality of second pixels where light transmitted through the lens optical system enters;
an area segmented optical attenuator device comprising a first light control part and a second light control part, which are located in the first optical region and the second optical region, respectively;
a control section for changing at least one of a transmittance of the first light control part of the area segmented optical attenuator device and a transmittance of the second light control part of the area segmented optical attenuator device; and
an array-patterned optical device, which is placed between the lens optical system and the image pickup device, for causing light transmitted through the first optical region to enter the plurality of first pixels and causing light transmitted through the second optical region to enter the plurality of second pixels.

2. The image pickup apparatus according to claim 1, further comprising a signal processing section for generating a high dynamic range image based on signals of the light incident on the plurality of first pixels and signals of the light incident on the plurality of second pixels.

3. The image pickup apparatus according to claim 1, wherein the image pickup device comprises a monochrome image pickup device.

4. The image pickup apparatus according to claim 1, wherein the lens optical system comprises an image-side telecentric optical system.

5. The image pickup apparatus according to claim 1, wherein the array-patterned optical device comprises a lenticular lens.

6. The image pickup apparatus according to claim 5, wherein, in the image pickup device, the plurality of first pixels and the plurality of second pixels are each aligned in a plurality of rows in a first direction, and the plurality of rows of first pixels aligned in the first direction and the plurality of rows of second pixels aligned in the first direction are arranged alternately in a second direction, which is orthogonal to the first direction, to constitute an image pickup surface.

7. The image pickup apparatus according to claim 1,
wherein the lens optical system further comprises a third optical region and a fourth optical region, and
wherein the area segmented optical attenuator device further comprises a third light control part, which is located in the third optical region, and a fourth light control part, which is located in the fourth optical region.

8. The image pickup apparatus according to claim 7, wherein the array-patterned optical device comprises a microlens array.

9. The image pickup apparatus according to claim 1,
wherein the area segmented optical attenuator device comprises at least three transmissive parts, of which adjacent two have different transmittances, and
wherein the control section comprises a driving mechanism for moving the at least three transmissive parts so that two arbitrary adjacent transmissive parts out of the at least three transmissive parts are located in the first optical region and the second optical region.

10. The image pickup apparatus according to claim 1,
wherein the area segmented optical attenuator device comprises:
a pair of polarizing plates;
a common transparent electrode, which is sandwiched between the pair of polarizing plates, and two divided transparent electrodes, which are respectively located in the first optical region and the second optical region; and
a liquid crystal layer, which is sandwiched between the common transparent electrode and the two divided transparent electrodes, and
wherein the control section applies different voltages to the two divided transparent electrodes.

11. The image pickup apparatus according to claim 10, wherein shooting operation is executed a plurality of times while varying the voltages.

12. The image pickup apparatus according to claim 1,
wherein the plurality of first pixels include a plurality of 1A pixels having a filter that has first spectral transmittance characteristics, a plurality of 2A pixels having a filter that has second spectral transmittance characteristics, a plurality of 3A pixels having a filter that has third spectral transmittance characteristics, and a plurality of 4A pixels having a filter that has fourth spectral transmittance characteristics,
wherein the plurality of second pixels include a plurality of 1B pixels having a filter that has the first spectral transmittance characteristics, a plurality of 2B pixels having a filter that has the second spectral transmittance characteristics, a plurality of 3B pixels having a filter that has the third spectral transmittance characteristics, and a plurality of 4B pixels having a filter that has the fourth spectral transmittance characteristics, and
wherein the array-patterned optical device comprises:
a plurality of first optical elements for causing the light transmitted through the first optical region to enter the plurality of 1A pixels and the plurality of 3A pixels, and causing the light transmitted through the second optical region to enter the plurality of 2B pixels and the plurality of 4B pixels; and
a plurality of second optical elements for causing the light transmitted through the first optical region to enter the plurality of 2A pixels and the plurality of 4A pixels, and causing the light transmitted through the second optical region to enter the plurality of 1B pixels and the plurality of 3B pixels.

13. The image pickup apparatus according to claim 12, wherein, on an image pickup surface of the image pickup device, each of the plurality of 1A pixels, each of the plurality of 2B pixels, each of the plurality of 3A pixels, and each of the plurality of 4B pixels are placed adjacent to one another at vertices of a square.

14. The image pickup apparatus according to claim 13,
wherein the filter that has the first spectral transmittance characteristics and the filter that has the second spectral transmittance characteristics comprise filters that transmit light of a green wavelength band,
wherein the filter that has the third spectral transmittance characteristics comprises a filter that transmits light of a red wavelength band,
wherein the filter that has the fourth spectral transmittance characteristics comprises a filter that transmits light of a blue wavelength band, and
wherein each of the plurality of 1A pixels, each of the plurality of 2B pixels, each of the plurality of 3A pixels, and each of the plurality of 4B pixels are arranged in a Bayer arrangement pattern.

15. The image pickup apparatus according to claim 12, wherein the plurality of first optical elements and the plurality of second optical elements each comprise a lenticular lens.

16. The image pickup apparatus according to claim 1, wherein the lens optical system further comprises a stop, and the first optical region and the second optical region are located near the stop.

17. An image pickup apparatus, comprising:
a lens optical system comprising a first optical region and a second optical region;
an image pickup device comprising a plurality of first pixels, a plurality of second pixels, a plurality of third pixels, and a plurality of fourth pixels where light transmitted through the lens optical system enters, the plurality of first pixels having a filter that has first spectral transmittance characteristics, the plurality of second pixels having a filter that has second spectral transmittance characteristics, the plurality of third pixels having a filter that has third spectral transmittance characteristics, the plurality of fourth pixels having a filter that has fourth spectral transmittance characteristics, the plurality of first pixels and the plurality of second pixels being arranged alternately in a first direction in a first row, the plurality of third pixels and the plurality of fourth pixels being arranged alternately in the first direction in a second row, the first row and the second row being arranged alternately in a second direction to form an image pickup surface;
an area segmented optical attenuator device comprising a first light control part and a second light control part, which are located in the first optical region and the second optical region, respectively;
a control section for changing at least one of a transmittance of the first light control part of the area segmented optical attenuator device and a transmittance of the second light control part of the area segmented optical attenuator device; and
an array-patterned optical device, which is placed between the lens optical system and the image pickup device,
wherein in the lens optical system, the first optical region and the second optical region being arranged in the second direction,
the array-patterned optical device comprising a plurality of optical elements for causing the light transmitted through the lens optical system to enter the image pickup surface for each set of four pixels comprising one of the plurality of first pixels, one of the plurality of second pixels, one of the plurality of third pixels, and one of the plurality of fourth pixels, the four pixels being arranged adjacent to one another in the first direction and the second direction,
the plurality of optical elements constituting a plurality of columns arranged linearly in the second direction, of two of the plurality of columns that are adjacent to each other in the first direction, each optical element in one column being staggered from its corresponding optical element in another column by a length half an arrangement cycle of the plurality of optical elements in the second direction.

18. A camera, comprising:
the image pickup apparatus according to claim 1;
an image displaying section;
a shutter button; and
an image saving section.
